(19) United States
(12) Patent Application Publication
(10) Pub. No.: US 2004/0123694 A1
(43) Pub. Date: Jul. 1, 2004

(54) Modular and reconfigurable parallel kinematic robot

(76) Inventor: Simone Pio Negri, Somma Lombardo (FI)

Correspondence Address: JACOBSON HOLMAN PLLC, 400 SEVENTH STREET N.W., SUITE 600, WASHINGTON, DC, 20004, US

(21) Appl. No.: 10/474,205

(22) PCT Filed: Apr. 15, 2002
(86) PCT No.: PCT/EP02/04251

(30) Foreign Application Priority Data
Apr. 19, 2001 (IT) MI2001A000830

(51) Int. Cl. B25J 17/00

(52) U.S. Cl. 74/490.01; 74/490.05

(57) ABSTRACT

The present invention describes a parallel kinematic robot comprising at least two fixed-length legs (6, 7, 60, 600, 800) positioned according to an isosceles triangle with one extremity converging in a common vertex coupled to a tool (9) by means of at least one first rotative joint (8, 81, 82) and the other extremity of each leg coupled by means of a second rotative joint (4, 5, 40, 50) to a respective trolley (2, 3) which can be translated along a first linear guide (1) lying in the plane of said isosceles triangle under the control of movement means.

### DESCRIPTION

The present invention refers to a modular and reconfigurable parallel kinematic robot.

Parallel kinematic robots are generally known in the state of the technique, that is robots comprising axes and/or four-bar linkages connected to a base or frame and to a platform to which a tool is generally associated; said axes are placed in parallel and are coupled to the frame and to the platform by means of movement means which permit the translation and/or the rotation in space in reply to a requested movement of the tool.

One of said parallel kinematic robots is composed of a machine comprising a frame composed of three guides; in each of said guides slides a trolley slides coupled to a kinematic chain consisting of a fixed-length leg with one extremity connected to the trolley and another extremity connected to a platform. The three legs all converge on the same platform to which a tool is associated. The machine gives the tool a movement with three degrees of freedom.

Another of said parallel kinematic robots consists of a machine comprising a frame composed of three linear guides; in each of said guides two trolleys slide, each one coupled to a kinematic chain consisting of a fixed-length leg with one extremity connected to the trolley by means of a cardan joint and another extremity connected to a platform by means of a ball joint. The six legs converge all on the same platform to which a tool is associated. The machine gives the tool a movement with six degrees of freedom.

The structure of the above-mentioned machine nevertheless does not enable it to be converted into a parallel kinematic machine with a number of degrees of freedom less than six, as the lack of one or more kinematic chains makes the machine itself uncontrollable.

In view of the state of the technique described, the object of the present invention is to produce a parallel kinematic robot that can be reconfigured easily and modularly in a robot with a different number of degrees of freedom.

In accordance with the present invention, said object is reached by means of a parallel kinematic robot characterized in that it comprises at least two fixed-length legs placed according to an isosceles triangle with one extremity converging in a common vertex coupled to a tool by means of at least one first rotative joint and the other extremity of each leg coupled by means of a second rotative joint to a respective trolley that can be translated along a first linear guide lying in the plane of said isosceles triangle under the control of movement means.

The configuration defined is the minimum configuration which thanks to the execution of one of the legs in the form of passive four-bar linkage can give origin to a planar structure with two degrees of freedom.

This minimum configuration is on the other hand modifiable so as to form a planar structure with three degrees of freedom, simply motorizing the other extremity of the leg with four-bar linkage.

The same minimum configuration can also give origin to a spatial structure with three degrees of freedom, making the rotative joints in the form of cardan joints and adding a third fixed length leg that extends in a plane perpendicular to that of said isosceles triangle between said common vertex and a third trolley sliding along a second linear guide, perpendicular to the first guide, under the control of another movement means.

Adding further equal or similar components such as fixed length legs, hinged rotative joints, ball or cardan joint and suitable motor means, the base robot can be further reconfigured and in a modular way making structures with more degrees of freedom.

The characteristics and advantages of the present invention will appear evident from the following detailed descriptions of embodiments thereof, illustrated as non-limiting examples in the enclosed drawings, in which:

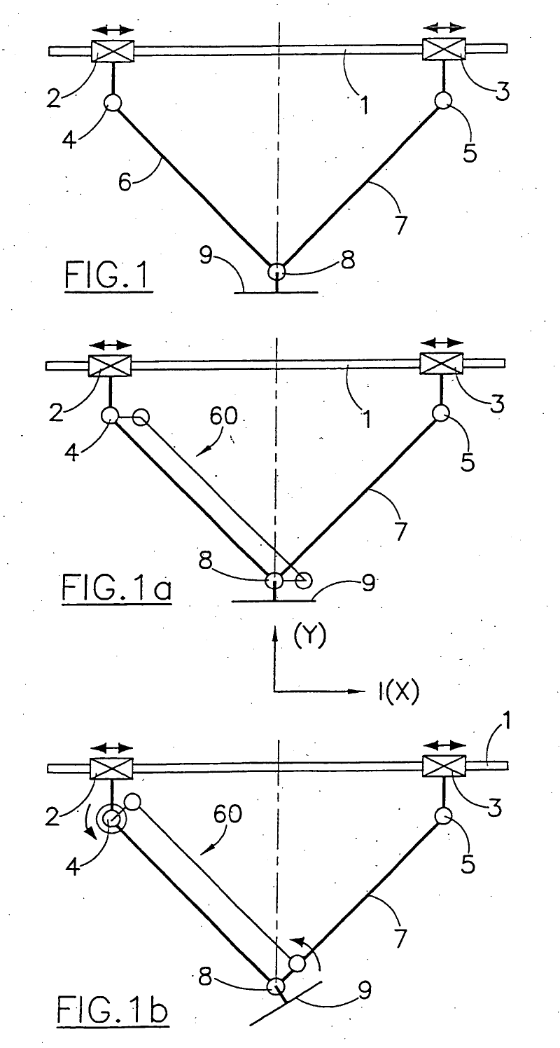

FIG. 1 is a front schematic view of a parallel kinematic robot according to a first embodiment of the present invention;

FIG. 1a is a front schematic view of a parallel kinematic robot according to a first variant to the first embodiment of the invention;

Figure 1b is a front schematic view of a parallel kinematic robot according to a second variant to the first embodiment of the invention;

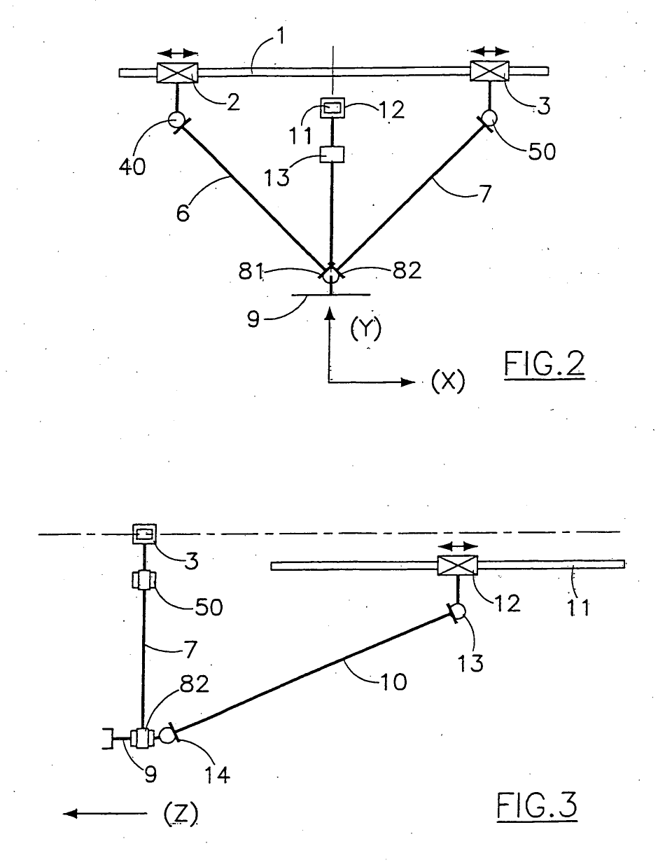

FIG. 2 is a front schematic view of a parallel kinematic robot according to a second embodiment of the present invention;

FIG. 3 is a side schematic view of the robot of FIG. 2;

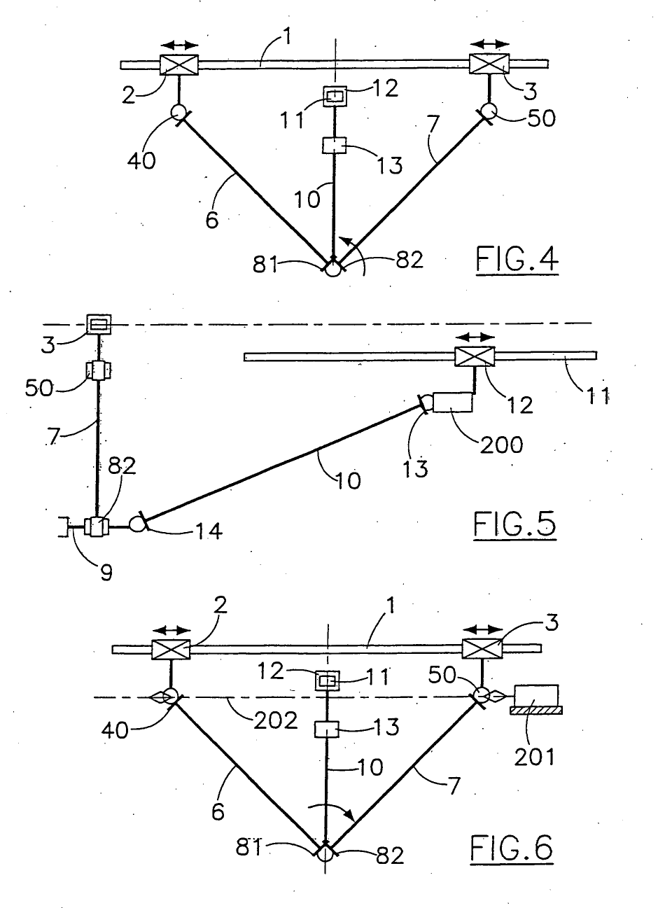

FIG. 4 is a front schematic view of a parallel kinematic robot according to a third embodiment of the present invention;

FIG. 5 is a side schematic view of the robot of FIG. 4;

FIG. 6 is a front schematic view of a parallel kinematic robot according to a fourth embodiment of the present invention;

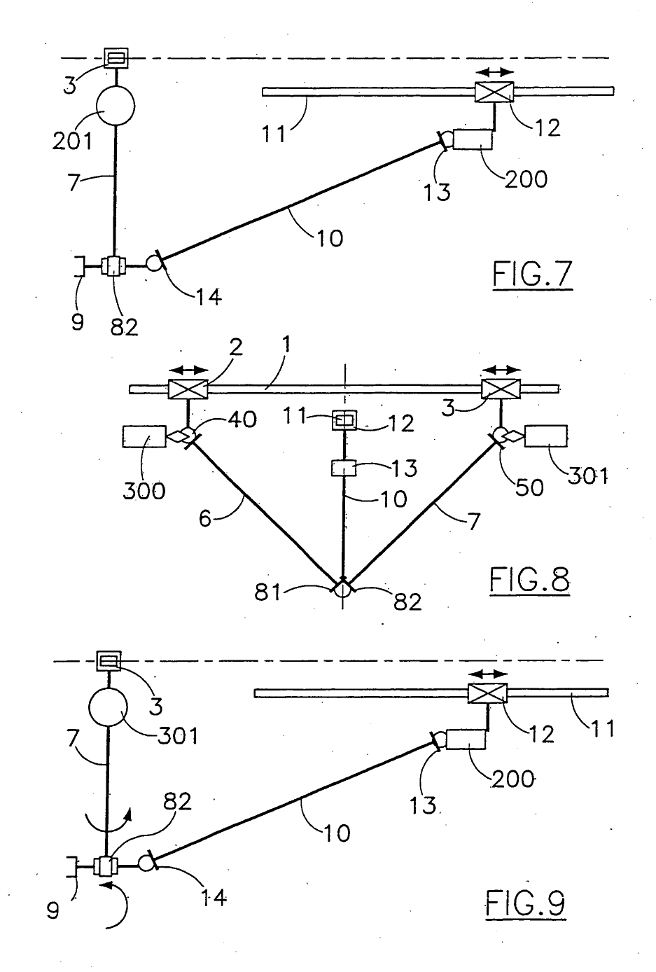

FIG. 7 is a side schematic view of the robot of FIG. 6;

FIG. 8 is a front schematic view of a parallel kinematic robot according to a fifth embodiment of the present invention;

FIG. 9 is a side schematic view of the robot of FIG. 8;

FIG. 10 is a front schematic view of a parallel kinematic robot according to a sixth embodiment of the present invention;

FIG. 11 is a side schematic view of the robot of FIG. 10;

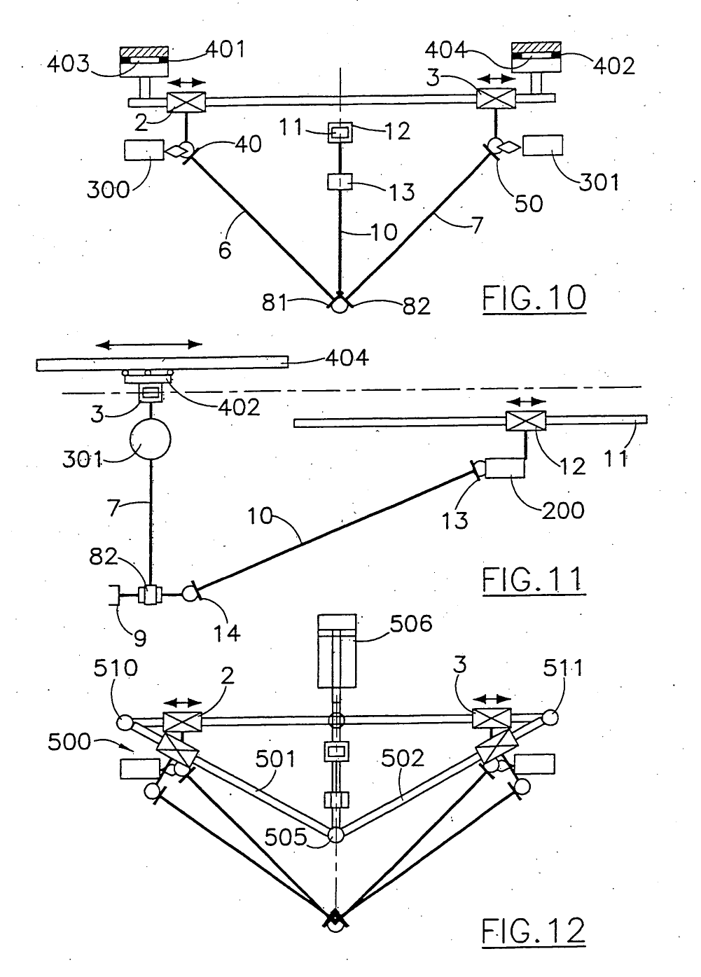

FIG. 12 is a front schematic view of a parallel kinematic robot according to a variant to the above-mentioned embodiments;

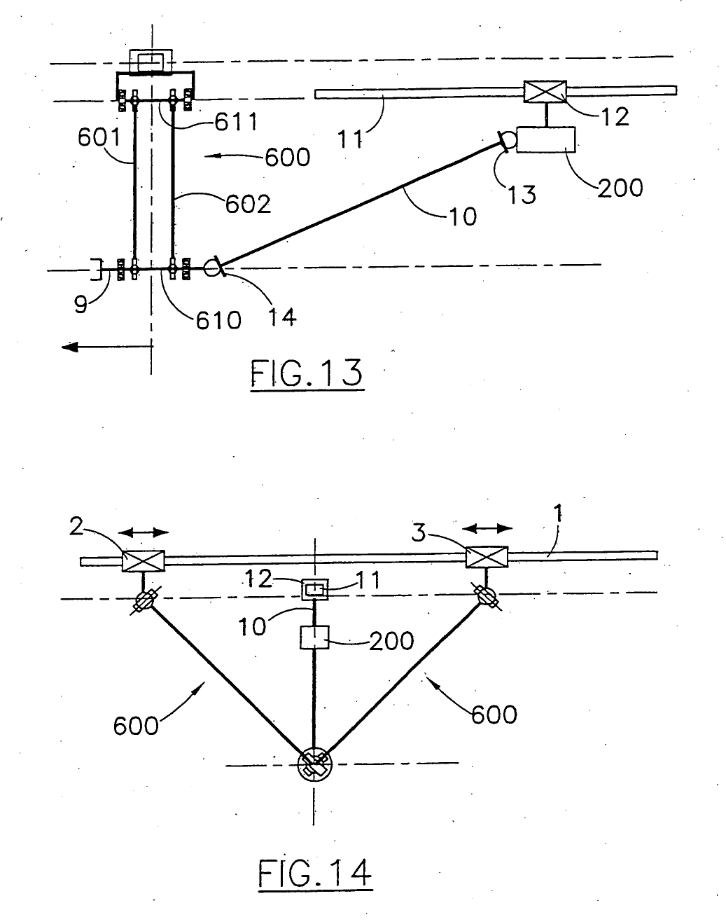

FIG. 13 is a side schematic view of a first four-bar linkage usable in the above-mentioned embodiments;

FIG. 14 is a front view of the four-bar linkage of FIG. 13;

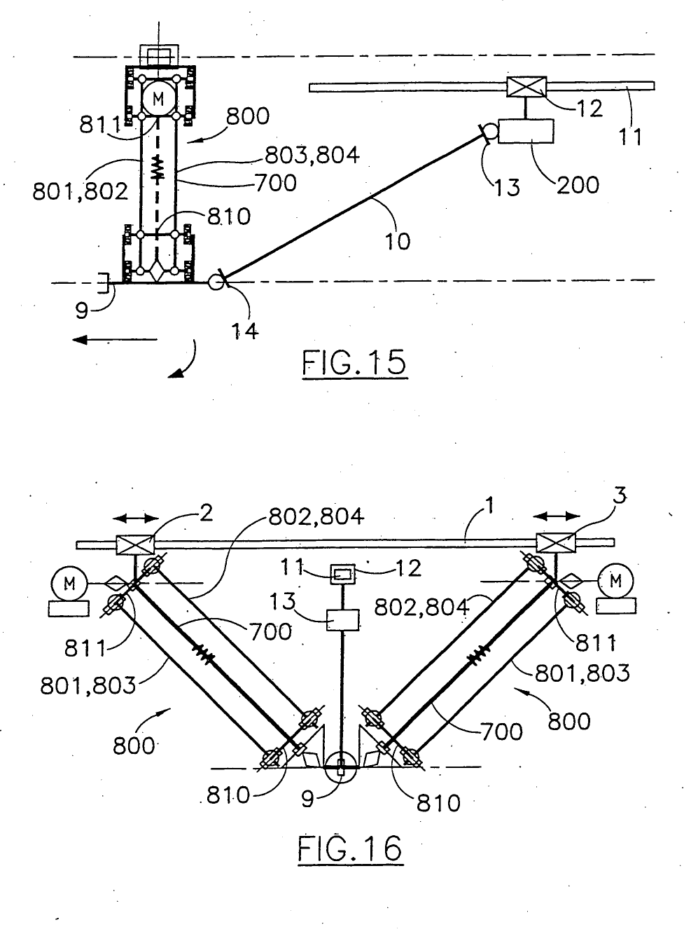

FIG. 15 is a side schematic view of a second four-bar linkage usable in the above-mentioned embodiments;

FIG. 16 is a front view of the four-bar linkage of FIG. 15.

With reference to FIGS. 1-12 the possible configurations of the parallel kinematic robot according to the present invention are shown.

The robot in accordance to a first embodiment of the invention is shown in FIG. 1. Said robot comprises a fixed frame equipped with a guide 1 on which two trolleys 2 and 3 slide equipped with hinged rotative joints 4 and 5 for connecting them to respective extremities of two fixed-length legs 6 and 7. Legs 6 and 7 are positioned at isosceles triangle with their other extremities converging in a common coupled vertex, by means of a further hinged rotative joint 8, to a platform 9 for the support of a tool. Trolleys 2 and 3 can be made for example by means of roller or ball recirculation guides and the activating system can be made through a ball recirculation screw or by means of a linear motor. That of FIG. 1 represents the minimum base configuration of the robot according to the present invention.

A parallel kinematic robot according to a first variant to the first embodiment is shown schematically in FIG. 1a. Said robot differentiates from robot of FIG. 1 for the execution of the leg 6 in the form of a four-bar linkage 60. Said four-bar linkage 60 for example can comprise four fixed length rods equipped with eight hinged rotative joints (four upper and four lower), or, alternatively, can comprise only two fixed length rods provided with four hinged rotative joints (two upper and two lower). The robot of said embodiment has two degrees of freedom as a translation of the tool is possible both along x-axis and along y-axis shown in FIG. 1.

A parallel kinematic robot according to a second variant to the first embodiment of the invention is shown schematically in FIG. 1b. Said robot differentiates from robot of Figure 1a because the hinged rotative joint, that couples the four-bar linkage 60 with the trolley 2, is provided with a motor to enable the rotation of the platform 9 around a z-axis orthogonal to the x and y-axes, therefore adding a degree of freedom compared to the robot of FIG. 1a.

A parallel kinematic robot according to a second embodiment of the present invention is shown schematically in FIGS. 2 and 3. The robot differentiates from the robot of FIG. 1 as it comprises a third fixed-length leg 10 which extends in an orthogonal plane to that of the isosceles triangle formed by the two legs 6 and 7 and guide 1. In fact said third leg 10 is connected to the common vertex of legs 6 and 7 and to a third trolley 12 coupled to a second guide 11 orthogonal to the first guide 1 by means of a rotative cardan type joint 13. The two trolleys 2 and 3 are also coupled to the two upper extremities of the two legs 6 and 7 positioned at isosceles triangle by means of rotative cardan type joints 40 and 50. The lower extremities of legs 6 and 7 converge in a common vertex and are connected to the mobile platform 9 by means of two cardan type rotative joints 81 and 82. The other extremity of leg 10 is connected to another cardan type rotative joint 14 connected in turn to the mobile platform 9.

Guide 11 can be positioned at a lower height compared to guide 1 to optimize the operation of the robot. Trolleys can be made for example by means of wheel or ball recirculation guides and the activating system can be made through a linear motor or ball recirculation screw. The tool that is integral to the cardan joint 14 can be installed in the front or the side. The robot of said embodiment has three degrees of freedom in fact if the movements of the two legs 6 and 7 enable the translations according to the x-axis (1° degree of freedom) and according to the y-axis (2° degree of freedom), the insertion of the third leg 10 enables a translation according to the z-axis (3° degree of freedom).

A parallel kinematic robot with four degrees of freedom according to a third embodiment of the present invention is shown schematically in FIGS. 4 and 5. With reference to the robot of FIG. 2 with three degrees of freedom, adding a rotation motor 200 coupled to the cardan joint 13, a rotation around z-axis (4° degree of freedom) is obtained.

A parallel kinematic robot with five degrees of freedom according to a fourth embodiment of the present invention is shown schematically in FIGS. 6 and 7. With reference to the robot of FIG. 4 with four degrees of freedom, by adding a rotation motor 201 coupled to one of the two cardan joints 40 and 50 (in the Figure at joint 50), and a transmission shaft 202 which transmits the rotation movement to the other of the two legs 6 and 7, a simultaneous rotation of the two legs 6 and 7 around the x-axis (5° degree of freedom) is obtained. The motor 201 is preferable integral with one of the two trolleys 2 or 3 or can be connected to ground.

A parallel kinematic robot with six degrees of freedom according to a fifth embodiment of the present invention is shown schematically in FIGS. 8 and 9. With reference to the robot of FIG. 4 with four degrees of freedom, by adding a rotation motor 300 coupled to the cardan joint 40 and a rotation motor 301 coupled to the cardan joint 50, an independent rotation around the x-axis (5° degree of freedom) and the y-axis (6° degree of freedom) is obtained.

A parallel kinematic robot with seven degrees of freedom according to a sixth embodiment of the present invention is shown schematically in FIGS. 10 and 11. With reference to the robot of FIG. 8 with six degrees of freedom, guide 1 is coupled to two trolleys 401 and 402 sliding on two guides 403 and 404 parallel to each other and to guide 11. Said solution enables a volume of work along the y-axis determined only by the length of the guides 403 and 404 to be obtained. Said solution can also be made to all the robot versions previously described according to the invention.

A parallel kinematic robot according to a variant to the six embodiments of the present invention is shown schematically in FIG. 12. With reference to the robot of FIG. 8 with six degrees of freedom, instead of the guide 1 a guide 500 is used, consisting of two semi guides 501 and 502 hinged in 505 and each one of them hinged to the fixed frame in 510 and 511; one of the trolleys 2 and 3 slides on each semi guide. A pneumatic or oleohydraulic drive system 506 is connected to the hinge 505 which enables the two semi guides 501 and 502 and the components coupled to them to be lowered or raised. Said solution enables a degree of non interpolated freedom to be added and can also be made to all the versions of the robot previously described according to the invention.

A common solution to all the previously described versions of the robot is to make a leg of the robot like a four-bar linkage. A first embodiment of said four-bar linkage can be seen in FIGS. 13 and 14; the four-bar linkage 600 comprises two rods 601 and 602 connected by means of four cardan type rotative joints 610, 611 with lower and upper segments.

A second embodiment of the four-bar linkage can be seen in FIGS. 15 and 16; a parallelogram 800 comprises four rods 801-804 connected by means of eight cardan rotative joints with lower and upper quadrilaterals 810 and 811. In FIGS. 15 and 16 each parallelogram 800 is provided, as an optional, with another motor M for the rotation of a central axis 700 associated with platform 9. Such version of the four-bar linkage can be used in the versions of the robot in which the motorization of at least one leg is provided for; in this case the leg with the motor associated is replaced by the version of the parallelogram 800 of FIGS. 15 and 16.

In alternative to the use of only one guide 1 associated to the fixed frame it is possible, even though it is not shown in the Figures, to use two guides parallel to each of which one of the Trolleys 2 or 3 is associated.

1. Parallel kinematic robot characterized in that it comprises at least two fixed length legs (6, 7, 60, 600, 800) positioned according to an isosceles triangle with an extremity converging in a common vertex coupled to a tool (9) by means of at least one first rotative joint (8, 81, 82) and the other extremity of each leg coupled by means of a second rotative joint (4, 5, 40, 50) to a respective trolley (2, 3) that can be translated along a first linear guide (1) lying in the plane of said isosceles triangle under the control of movement means.

2. Robot according to claim 1, characterized in that said first linear guide (1) is composed of a first and a second semi guide parallel to each other, to each of which a trolley (2, 3) is associated.

3. Robot according to claim 1 o 2, characterized in that said second rotative joints (4, 5) are hinged rotative joints and at least a first joint (8) is a hinged rotative joint.

4. Robot according to claim 3, characterized in that one (4) of said first hinged rotative joints (4, 5) is provided with a motor for the rotation of one (60) of said two legs (7, 60).

5. Robot according to claim 4, characterized in that said leg (60) associated to said motor is a four-bar linkage (60), while the other leg (7) is a rod.

6. Robot according to claim 1 or 2, characterized in that it comprises a third leg (10) with an extremity coupled with the common vertex of said two legs (6, 7, 600, 800) positioned at isosceles triangle and with the other extremity coupled by means of a further rotative joint (13) to another trolley (12) which can be translated on a second linear guide (11) perpendicular to the first guide (1) by means of further movement means.

7. Robot according to claim 6, characterized in that said at least one first rotative joint (81, 82) comprises two first rotative joints (81, 82) of the cardan type and the second rotative joints (40, 50) of said legs (6, 7) positioned at isosceles triangle are the cardan type, said third leg (10) being. coupled with the common vertex of said two legs (6, 7) by means of a rotative joint of the cardan type (14) and also its rotative joint (13) connecting the trolley (12) being the cardan type.

8. Robot according to claim 7, characterized in that the cardan joint (13) associated to said third leg (10) and to the respective trolley (12) is provided with a motor (200) for the rotation of the leg (10).

9. Robot according to claim 8, characterized in that a first cardan joint (50) associated to one (7) of the two legs (6, 7) at isosceles triangle is provided with a motor (201) for the rotation of said one leg (7), said motor (201) being associated to a motion transmission means (202) connected to the other (6) of said two legs (6, 7) so as to enable the simultaneous rotation of the two legs (6, 7) positioned at isosceles triangle.

10. Robot according to claim 8, characterized in that the first cardan joints (40, 50) associated to the two legs (6, 7) positioned at isosceles triangle are both provided with a motor (300, 301) for the rotation of each leg (6, 7).

11. Robot according to claim 10, characterized in that said first guide (1) is associated to other trolleys (401, 402) that can be translated along further guides (403, 404) perpendicular to said first guide (1) under the control of movement means so as to enable a translation of first guide (1).

12. Robot according to any previous claims, characterized in that said first guide (1) comprises two linear semi guides (501, 502) hinged to each other, each of said semi guides (501, 502) is coupled to a fixed frame by means of hinged rotative joints (510, 511), said robot comprising a system (506) for lowering and raising the two semi guides (501, 502) which is connected to a hinge (505) of connection of the two semi guides (501, 502).

13. Robot according to claim 6, characterized in that said three legs (6, 7, 10) are rods.

14. Robot according to claim 6, characterized in that at least one (800) of said three legs is a four-bar linkage, said four-bar linkage (800) comprising four rods (801-804) connected by means of eight cardan type rotative joints with lower (810) and upper (811) quadrilaterals.

15. Robot according to claim 14, characterized in that said four-bar linkage (800) comprises a central axis (700) associated to a motor (M) for the rotation of said axis (700).

16. Robot according to claim 6, characterized in that at least one (600) of said three legs is a four-bar linkage, said four-bar linkage (600) comprising two rods (601-602) connected by means of four cardan type rotative joints with upper (610) and lower (611) segments.
